(19) United States
(12) Patent Application Publication
(10) Pub. No.: US 2005/0123183 A1
(43) Pub. Date: Jun. 9, 2005

(54) Data driven motion correction for nuclear imaging

(76) Inventors: Paul Schleyer, Altona (AU); Graeme O'Keefe, Mont Albert (AU); Andrew Scott, Kew (AU)

Correspondence Address: FULBRIGHT & JAWORSKI, LLP, 666 FIFTH AVE, NEW YORK, NY, 10103-3198, US

(21) Appl. No.: 10/930,376

(22) Filed: Aug. 31, 2004

Related U.S. Application Data
(60) Provisional application No. 60/499,486, filed on Sep. 2, 2003.

(51) Int. Cl. G06K 9/00; G06K 9/40

(52) U.S. Cl. 382/131; 382/254

(57) ABSTRACT

The present invention relates to a system and method of correcting respiratory induced motion in nuclear medicine imaging. Images are acquired dynamically, and gated post-acquisition, generating a series of near motion-free bins. These bins are then aligned to produce a motion corrected image without extending the acquisition time.

### RELATED APPLICATIONS

This application claims benefit of U.S. Provisional Application Ser. No. 60/499,486 filed Sep. 2, 2003, which are incorporated by reference in its entirety.

### BACKGROUND OF THE INVENTION

The present invention relates to a motion correction system and method, particularly to a system and method for correcting respiratory induced motion in nuclear medicine imaging. The invention is useful in the study of organs which exhibit mobility, including, but not being limited to lungs, the heart, the liver, and other organs which exhibit this characteristic.

The respiratory cycle involves motion of several organs, which are commonly of interest in nuclear medicine imaging. Due to the prolonged acquisition duration, breath hold techniques cannot be employed to reduce motion artifacts. As a result, respiratory induced motion can adversely affect the qualitative and quantitative accuracy of the image.

Organs subject to respiratory motion include but are not limited to the liver, heart, lungs and kidneys, and the extent of the motion depends on the organ, and level of respiration. Under quiet respiration, it has been observed that the liver moves about 10-40 mm, the pancreas about 10-30 mm, and the kidneys about 20-70 mm. The heart moves upward and downward with the diaphragm, and undergoes non-rigid deformation. The entire cycle duration is approximately 4.4 seconds, and can vary substantially.

Respiratory motion has been found to cause significant artifact in Single-Photon Computed Tomography (SPECT) imaging, particularly when assessing the inferior wall of the left ventricle. Respiratory gating the acquisition is suggested as the only means of correcting for the motion artifact. Respiratory motion also impacts the quantification of Positron Emission Tomography (PET) cardiac images, and can lead to decreased accuracy in measuring radiotracer uptake. The respiratory gating of PET images has been demonstrated to provide more accurate tumor quantification, leading to lower standard uptake values (SUV). Further, respiratory induced motion can also reduce the accuracy in planar image dosimetry analysis. Therefore, respiratory gating may increase quantitative dosimetry accuracy.

Previously developed techniques to correct for respiratory induced motion include methods which gate the acquisition using a signal obtained directly from respiratory sensors fitted to the patient. However, methods which determine the respiratory signal from the centre of mass of the image are restricted. Non-moving structures with significant uptake within the field of view, may reduce the sensitivity and accuracy of the gating. Furthermore, these methods only retain data acquired from a fraction of the respiratory cycle, discarding remaining data. Therefore, it is desirable to have a system and method of data driven respiratory gating which overcomes these limitations.

### BRIEF SUMMARY OF THE INVENTION

It is an object of the present invention to overcome the shortcomings described supra.

Another object of the present invention is to provide a system and method for correcting motion in nuclear medicine imaging, such as, but not being limited to, respiratory induced motion.

The system and method of data driven respiratory gating of the present invention is applicable to a wide range of nuclear medicine imaging techniques. In accordance with an embodiment of the present invention, the system dynamically acquires the images and respiratory gates the acquired images to generate a series of near motion-free bins. The system then aligns these near motion-free bins to produce a motion corrected image without extending the acquisition duration. Also, the system can reconstruct the original non-corrected image by summing the non-aligned bins.

In accordance with an embodiment of the present invention, the respiratory motion correction technique and system utilize a temporal spectral analysis to determine the spatial regions in a dynamic scan which are subject to respiration motion. The present inventive system and method then determines where, in the displacement phase of the respiration cycle, each frame lies from the change in counts within these spatial regions which are subject to respiration motion throughout the dynamic scan. The inventive system and method places these frames into bins which contain other frames from equal displacement phases of the respiratory cycle, thereby effectively data gating the acquisition with a displacement based trigger, rather than temporally based. It is appreciated that temporal information is not ideal for respiratory analysis because it requires regular respiratory cycles. In accordance with an embodiment of the present invention, the inventive system and method processes list mode acquired data and images acquired as a dynamic scan, of short frame duration relative to respiratory period, so that minimal motion occurs during each frame. In list mode, the image acquisition device (e.g., a gamma camera) time-stamps each individual event detected so that the data can be arbitrarily framed post acquisition rather than accumulating all counts from a given time range into a frame as in the dynamic scan.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the specific concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a functional diagram of a computer or processor 100 in accordance with an embodiment of the present invention;

FIG. 2 is a flow chart describing the process of correcting respiratory induced motion in nuclear medicine imaging in accordance with an embodiment of the present invention;

FIGS. 3A-3C are exemplary graph illustrating frequency magnitude of pixels from liver spleen scans, showing background, edge of liver (respiratory frequency spike circled), and center of liver, respectively;

FIG. 4 is an exemplary binning of the filtered counts-time series into equal count-range in accordance with an embodiment of the present invention;

FIGS. 5A-5E are NCAT planar simulations of stationary image (i.e., non-moved), non-corrected 2 cm amplitude image, non-corrected 4 cm amplitude image, corrected 2 cm amplitude image and corrected 4 cm amplitude image, respectively;

FIG. 6 is a graph of Edge Magnitude Range (EMR) plot of stationary (solid), non-corrected (dashed), and corrected (dotted) NCAT planar images in accordance with an embodiment of the present invention;

FIG. 7 is a ROIs drawn on stationary image of whole liver, sample liver, and background; and

FIG. 8 is a NCAT liver counts of stationary (solid), non-corrected (dashed), and corrected (dotted) images.

### DETAILED DESCRIPTION OF THE INVENTION

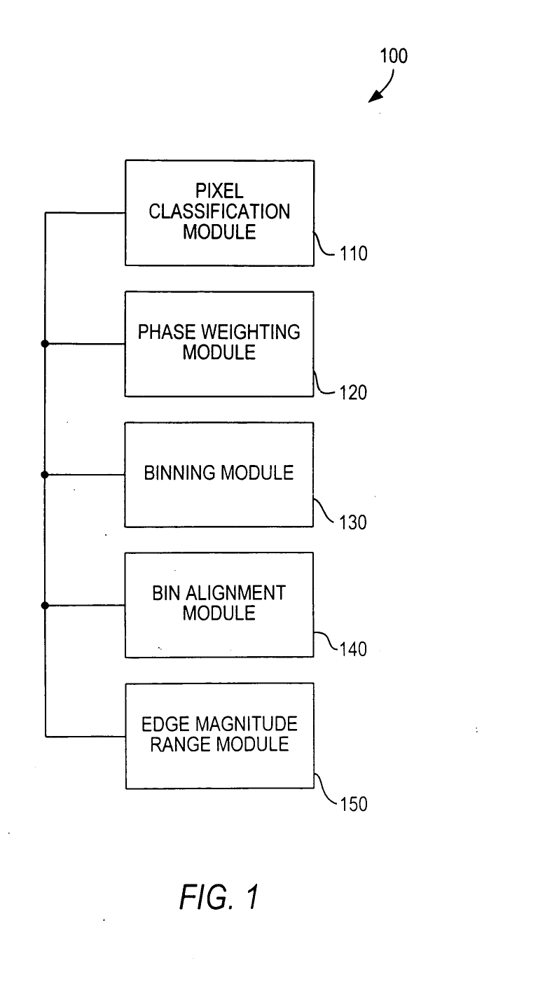

In accordance with an aspect of the present invention, the data driven respiratory motion correction method for nuclear medicine imaging is a software program running on a processor or computer 100 of FIG. 1.

In accordance with an embodiment of the present invention, the processor 100 comprises one or more modules or routines performing the various steps of the data driven respiratory motion correction method. The processor 100 comprises a pixel classification module 110, a phase weighting module 120, a binning module 130 and a bin alignment module 140.

The processor 100 receives a dynamic image of the target organ having a plurality of frames, preferably a moving organ or an organ subject to respiratory motion, from any known nuclear medicine image system. After the dynamic image is acquired, the pixel classification module 110 and the phase weighting module 120 determine the spatial regions in a dynamic scan of the target organ, which are subject to respiratory motion. The pixel classification module 110 applies a binary mask to the frames of the dynamic image to classify the pixels, e.g., eliminate pixels not demonstrating respiratory motion characteristics. The phase weighting module 120 weights the binary mask with a phase to prevent canceling out of counts from the trailing and leading edges of the a moving organ or the target organ. The binning module 130 and the bin alignment module 140 determine and utilize the change in counts within the spatial regions to ascertain where each frame lies in the displacement phase of the respiratory cycle. The binning module 130 bins or places frames into bins containing other frames from equal displacement phases of the respiratory cycle, effectively data gating the acquisition with a displacement based trigger.

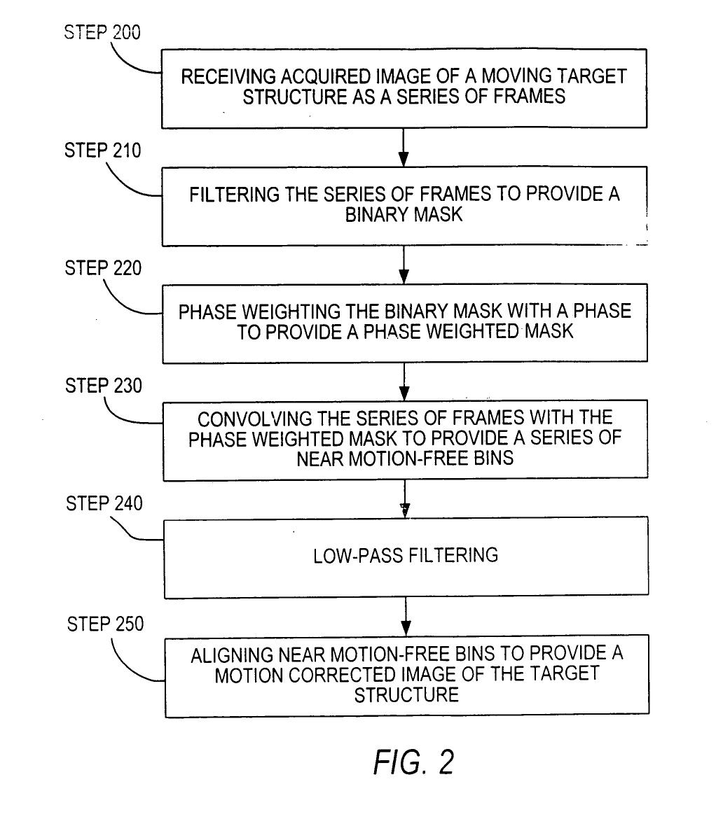

Turning now to FIG. 2, there is illustrated a flow chart detailing the process of correcting motion in nuclear medicine imaging, such as respiratory induced motion, by the processor 100 in accordance with an embodiment of the present invention. The processor 100 receives an acquired image, preferably dynamic image, of the target structure, such as an organ (heart, liver, lungs, spleen, etc.), tumor, growth, lump, cancerous cell, etc., in step 200. For example, the dynamic image is a series of dynamic frames, i.e., Z=1200 temporally contiguous, 128×128 frames, each of duration T=100 msec. The processor 100 then bins this set of data (i.e., a series of dynamic frames) into optimally determined “R” respiratory bins. In accordance with an embodiment of the present invention, the number of respiratory bins or the value of R can be function of the degree of motion of the target structure, such as the mean organ motion with a bin being limited to order of 1 mm.

The pixel classification module or routine 110 of the processor 100 generates a filtered set of data by temporally and spatially Gaussian smoothing (one pixel full width half maximum) the frames to eliminate pixels not demonstrating respiratory motion characteristics in step 210. Since the respiration cycle is quasi-sinusoidal, the respiratory induced motion contains a dominant frequency component with approximately the same period as the respiration cycle itself. Accordingly, the pixel classification module 110 performs Fast Fourier transform (FFT) of the volume in the temporal domain, providing a frequency spectrum for each pixel on the XY plane in step 210. The FFT produces an array as defined by Equation (1),

$$F ( u ) = \frac{1}{Z} {\sum }_{x = 0}^{Z - 1} F ( t ) {ⅇ}^{\frac{- j 2 π u t}{z}} \qquad ( 1 )$$

where the index u of the array F(u) corresponds the frequency Fᵤ, as defined by Equation (2):

$${F}_{u} = \frac{u}{ZT} u = 0 , 1 , … , \frac{1}{2 T} ( if Z is even ) \qquad ( 2 )$$

where T is the sample period, and Z is the number of samples.

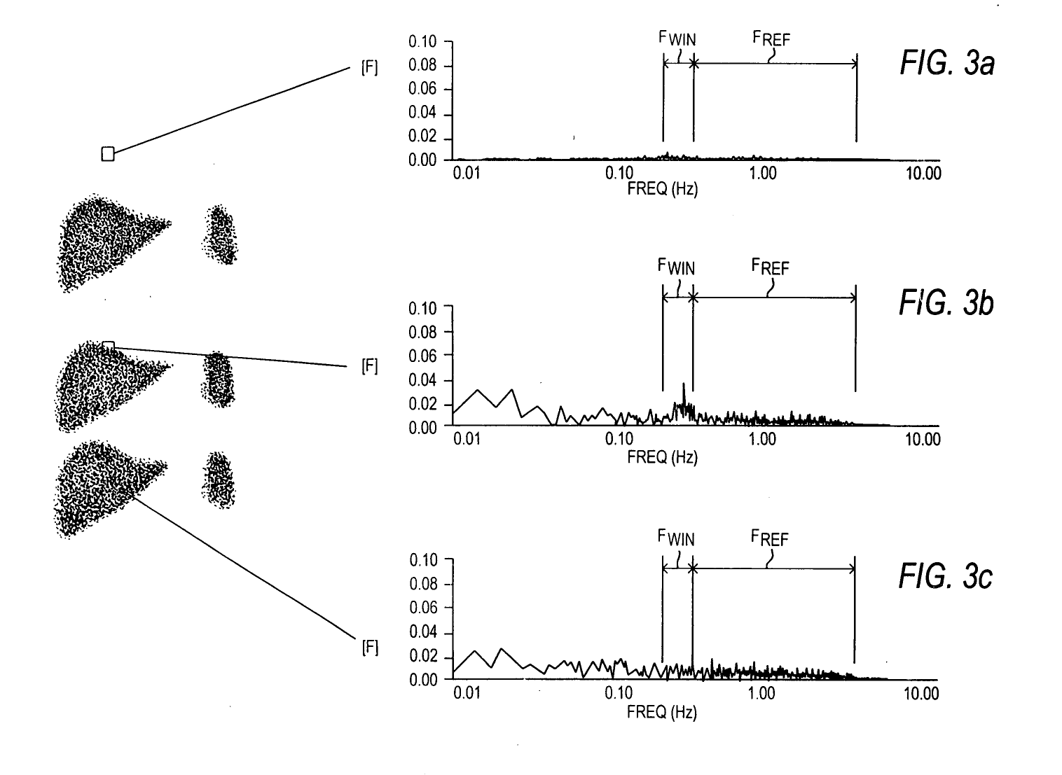

It is appreciated that a pixel which lies on an edge of a feature or organ subject to motion contains different frequency components than a pixel which lies inside a non-moving region, or in a homogeneous moving region, as shown in FIG. 3. By specifying upper and lower frequencies, Fᵤₚ and Fₗₒ respectively, around the estimated respiration frequency Fᵣ, the pixel classification module 110 calculates the average amplitude of the frequencies in the search window F_{win} using Equation (3):

$${\overline{F}}_{win} ( i , j ) = \frac{1}{2 W} {\sum }_{u = {u}_{r} - W}^{{u}_{r} + W} \vert F ( i , j , u ) \vert \qquad ( 3 )$$

where uᵣ is the index which corresponds to Fᵣ, and W is the width in sample points of the search window as defined by Equation (4):

$$W = \frac{1}{2} ( {F}_{lo} ZT - {F}_{up} ZT ) \qquad ( 4 )$$

Since the respiratory cycle is typically 4.4 seconds, the pixel classification module 110 used 0.225 Hz as an estimate of respiratory frequency Fᵣ to calculate the average amplitude of the frequencies in the search window F_{win}.

For the same pixel, the pixel classification module 110 calculates the average magnitude of a reference window F_{ref} located over a higher frequency range than F_{win}. The window frequency range commences at double the search window width W, above the highest index of the search window to the highest frequency resulting from the FFT, Z/2. The distance between the two windows ensures no respiratory signal is included in the reference window. The reference window is defined by Equation (5) as:

$${\overline{F}}_{ref} = \frac{1}{\frac{Z}{2} - ( {u}_{r} + 2 W )} {\sum }_{u = {u}_{r} + 2 W}^{\frac{Z}{2} - 1} \vert F ( i , j , u ) \vert \qquad ( 5 )$$

The reference windows allow the pixel classification module 110 to determine a ratio of respiratory signal power to non-respiratory signal power in. The pixel classification module 110 specifies a power independent selection criteria, generating an M×N binary mask in step 210, from the following relationship or Equation (6):

$$mask ( i , j ) = \{ \begin{matrix}1 & if \frac{{\overline{F}}_{win} ( i , j )}{{\overline{F}}_{ref} ( i , j )} \geq T \\ 0 & if \frac{{\overline{F}}_{win} ( i , j )}{{\overline{F}}_{ref} ( i , j )} < T\end{matrix} \qquad ( 6 )$$

where T is a threshold which characterizes the sensitivity of the inventive process. It is appreciated that this threshold T can be determined experimentally. In an exemplary application, the pixel classification module 110 applied a 3×3 median filter to the binary mask as defined by Equation (6) to reduce “salt and pepper” noise, i.e., data drop-out noise. The pixel classification module 110 applies this mask, which represents pixels of significant power, to the original frames to eliminate pixels not demonstrating respiratory motion characteristics.

The binary mask determines which regions in the X-Y plane contain the edge of a moving structure. The phase weighting module 120 weights the mask with a phase to prevent the canceling of counts from the trailing and leading edges of a moving organ which exists in the field of view in step 220. It is appreciated that the temporal binning procedure relies on the total counts in the masked image varying proportionally with the respiratory motion. If only the binary mask is applied then the net counts resulting from the masked image of a structure or organ with a leading and trailing edge of motion would be unchanged. That is, the counts defined in the leading edge plus the counts defined in the trailing edge would approximately sum to a constant, thereby giving no count change and hence no related inferred displacement change. In accordance with an embodiment of the present invention, the processor 100 can define the leading edge as an edge of increasing counts and the trailing edge as an edge of decreasing counts by applying the phase mask to the image. This enables the processor 100 to integrate the resultant edge and phase masked image to provide a net count that reflects the displacement of the organ, thereby allowing the present invention to bin the temporal frames on the basis of displacement rather than time. Additionally, this provides a temporal coherence weighting on the mask.

For each nonzero pixel in the mask, the phase weighting module 120 finds or determines the maximum frequency magnitude Fₘₐₓ in the search window F_{win} of the corresponding image using the following Equation (7):
Fₘₐₓ(i,j)=max[|F(i j, u_{r-w})|, . . . , |F(i,j, u_{r+w})|] (7)

The phase weighting module 120 determines the median value of all maximum frequency magnitudes of nonzero pixels in the masked image Fₘₐₓ and subsequently utilizes the determined median value to calculate the phase of motion using Equations (8) and (9). In accordance with an embodiment of the present invention, the phase weighting module 120 determines the phase of F(x, y, u) at Fₘₐₓ:
\overline{F}ₘₐₓ=median(Fₘₐₓ) (8)
θ(i,j)=arg(F(i,j,uₘₐₓ) (9)
where uₘₐₓ is the index of the frequency Fₘₐₓ determined by Equation (2). The phase weighting module 120 then obtains a phase histogram of θ(i, j) with a bin size of π/N and a range of 0 to 2π. The phase weighting module 120 then determines the histogram peak at phase angle θₘₐₓ.

The phase weighting module 120 forms an M×N weight matrix Ω according to the following weighting function or Equation (10):
Ω(i,j)=cos(θ(i,j)−θₘₐₓ) (10)
which defines the phase weighted mask in step 220. The phase weighting module 120 shifts the angle θ(i, j) by θₘₐₓ in the weighting function or Equation (10) to assign the maximum weighting value of one to the most frequently occurring phase angle, which is associated with the primary edge.

The inventive phase weighting technique of the phase weighting module 120 forms an automated and robust method of utilizing a large portion of the binary mask, and applying a coherence weighting to each pixel. The phase weighting module 120 utilizing the inventive phase weighting techniques can process both rigid and non-rigid bodies. A structure (i.e., organ) which deforms during motion generally posses edges of various phases and in accordance with an embodiment of the present invention, the phase weighting module 120 identifies the edge with the strongest specific frequency characteristics as being the primary phase, θₘₐₓ. The phase weighting module 120 includes other edges, if existing, in the mask and in accordance with an aspect of the present invention, penalizes other edges if their phase varies from 0° or 180°, according to the weighting function or Equation (10).

The binning module 130 initializes a series of R bins as blank M×N images. The binning module 130 convolves frames with the phase weighted mask defined by phase weighting module 120, and obtains total counts per frame, i.e., counts-time series or phase weighted counts in step 230. The binning module 130 low-pass filters, such as using a digital filter function in the interactive data language (IDL) of Research Systems, Inc., Boulder, Colo., the counts-time series to remove high frequency noise in step 240. In the exemplary application, the binning module 130 utilized the digital filter function with the following settings: 10th order, flow=0, fhigh=0.7, A=50. It is appreciated that any low-pass filter, preferably a digital low-pass filter, can be used to remove the high frequency noise. After filtering the count-time series, the binning module 130 divides the range of the filtered series into R equally sized displacement bins. It is appreciated that this is in contrast to standard gating techniques, which partition data into temporal bins.

Additionally, the binning module 130 places each of the original, unfiltered frames in the appropriate bin by referencing the filtered counts-time series. For example, a frame which was acquired at time t′ corresponds to c_{t′} counts on the filtered counts-time series. This frame was then placed into the displacement bin r, given by Equation (11):

$$r = \{ \begin{matrix}⌊ \frac{{C}_{t}^{′} - {C}_{min}}{\frac{{C}_{range}}{R}} ⌋ & if {C}_{min} \leq {C}_{t}^{′} < {C}_{max} \\ R - 1 & if {C}_{t}^{′} = {C}_{max}\end{matrix} \qquad ( 11 )$$

where cₘᵢₙ and cₘₐₓ are the minimum and maximum counts in the filtered counts-time series.

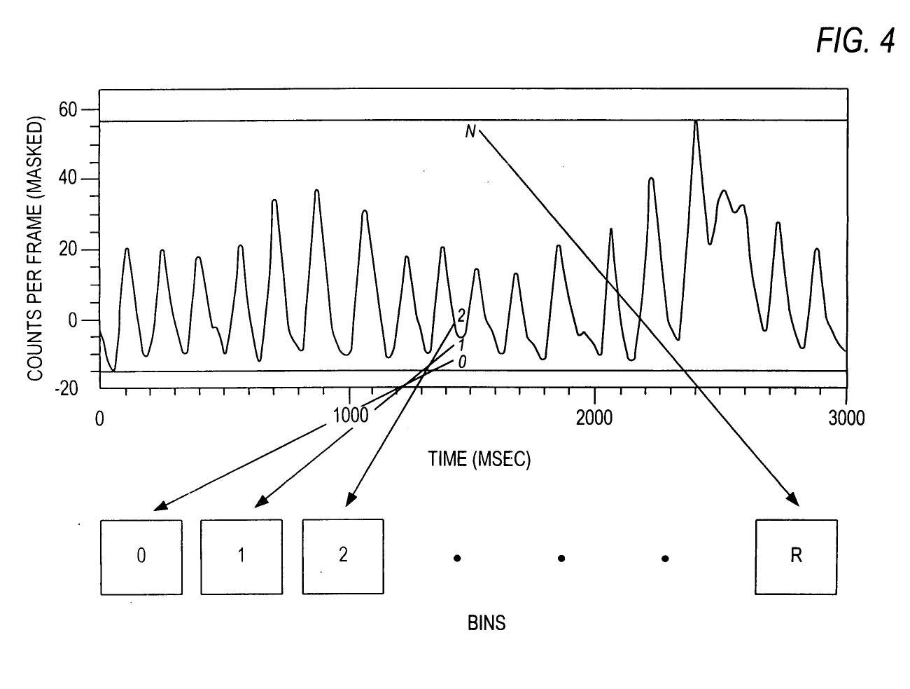

In accordance with an embodiment of the present invention, the binning module 130 divides the phase weighted counts into bins of equal count-range as opposed to equal time-ranges, as shown in FIG. 4. For example, a typical maximum amplitude of 2 cm for the phase weighted counts and R=16 (i.e., the number of near motion-free bins) translates to a maximum of 1.25 mm of respiratory induced motion in each near motion-free bin.

After the frames have been placed in the appropriate bins by the binning module 130, the bin alignment module 140 aligns the near motion-free bins to provide a motion corrected image of the target structure, i.e., organ, in step 250. The bin alignment module 140 registers the near motion-free bins using linear, rigid body registration relative to the organ of interest (i.e., linear registration), such as Automated Image Registration (AIR). The bin alignment module 140 adjusts the threshold of the summed frames until the organ of interest (i.e., the target organ) is not connected to any adjacent structures and selects a seed point within the target organ. The bin alignment module 140 then generates an organ specific binary mask from the selected seed point to the threshold defined border of the structure. It is appreciated that this is an organ specific spatially defined mask as opposed to the binary mask determined from the frequency characteristics of the image data in step 210 by the pixel classification module 120 using Equation (6). In accordance with an embodiment of the present invention, the bin alignment module 140 determines the organ specific binary mask from the summed non-motion corrected data. After the organ specific binary mask is grown or generated, in accordance with an embodiment of the present invention, the bin alignment module 140 morphologically dilates the organ specific binary mask using the following Equation (12) to ensure the binary mask encompasses the entire area of organ motion:

$$X ⊕ B = {⋃}_{b ∈ B} {X}_{b} \qquad ( 12 )$$

where X is the image, and B defines the nature of the dilation, as shown below.

In accordance with an embodiment of the present invention, the bin alignment module 140 applies morphologically dilated mask to the near motion-free bins prior to linear registration with the reference bin. It is appreciated that applying this morphologically dilated mask to the individual near motion-free bins enables the bin alignment module 140 to apply the AIR process to the target structure or organ without being confounded or constrained by other aspects of the image, such as the planagram image. In accordance with an embodiment of the present invention, the AIR is used in linear affine mode to determine a rigid body transformation, thereby generating a transformation consisting of 3 translation components and 3 rotation angles. The reference bin is the near motion-free bin that contains the greatest number of frames or the highest count statistics. In other words, the reference bin corresponds to the displacement at which the target organ or structure spends the most time. The bin alignment module 140 then applies these transformations to the original non-masked bins to provide aligned bins and sums the aligned bins to form a motion corrected image (with respect to the organ of interest) of equal statistics to the non-corrected image.

$$B = ( \begin{matrix}0 & 1 & 0 \\ 0 & 1 & 0 \\ 1 & 1 & 1 \\ 0 & 1 & 0 \\ 0 & 1 & 0\end{matrix} ) \qquad ( 13 )$$

In accordance with an embodiment of the present invention, the processor 100 comprises an edge magnitude range module 150 for calculating an edge magnitude range (EMR) metric to quantify the degree of image restoration or the level of image degradation induced by motion, thereby enabling the inventive system and method to make a comparative assessment of image quality. In accordance with an embodiment of the present invention, the EMR of the image f(x, y) is defined by Equation 14 as the normalized quantity,

$$EMR = \frac{range ( g ( x , y ) )}{total ( f ( x , y ) )} \qquad ( 14 )$$

where g(x, y) is the edge magnitude image defined by Equation (15).
g(x, y)=f(x, y)*h(x, y) (15)

The edge detector operator h(x, y) in Equation (16) is defined as,

$$h ( x , y ) = ( \begin{matrix}1 & 1 & 1 \\ 2 & 2 & 2 \\ 3 & 3 & 3 \\ 0 & 0 & 0 \\ - 3 & - 3 & - 3 \\ - 2 & - 2 & - 2 \\ - 1 & - 1 & - 1\end{matrix} ) \qquad ( 16 )$$

which enables the edge magnitude range module 150 to calculate the vertical edge magnitude.

In accordance with an embodiment of the present invention, the inventive system and method analyzed a series of simulated planar images of a breathing torso to quantitatively determine the level of image degradation and assess the improvement in the accuracy of dosimetry. In an exemplary application, the Monte Carlo SimSET code simulated a series of planar images generated using 4D nurbs-based cardiac-torso (NCAT) phantom. The Monte Carlo SimSET is a Monte Carlo simulation software (or camera simulator) generally used in emission tomography. For example, SimSET simulated seven ellipsoid model digital phantoms over a range of amplitudes. One moving ellipsoid, and a second non-moving ellipsoid of similar dimensions, were placed inside a cylinder containing background activity. A small point source was placed outside the cylinder and assigned equal motion parameters as the moving ellipsoid. The processor 100 of the present invention then removed the point source and applied the inventive motion correction methodology to the moving ellipsoid to quantify the degree of image restoration. That is, the inventive processor 100 calculated full width half maximum (FWHM) values using the point source and the edge magnitude range module 150 of the processor 100 calculated EMR values for the moving ellipsoid. A high correlation was found between the EMR and FWHM values (r=0.96).

In another exemplary application of the present invention, SimSET simulated a series of NCAT phantom image sets over a range of seven diaphragmatic amplitudes, from 1 cm to 7 cm. Respiratory and cardiac cycles were set to a period of 5 sec and 1 sec, respectively. A total of fifty activity and attenuation index volumes were generated for each amplitude, at 100 msec intervals throughout the five second cycle of simulated respiratory motion. Volumes were 128×128×128, with a voxel size of 0.3125 cm. A voxel or volume pixel is the smallest distinguishable box-shaped part of a three-dimensional image.

All SimSET simulations were performed using identical NCAT parameters with the exception of the amplitude of respiratory motion. The organ activity distribution was set to that of a typical ^{99m}Tc Sestamibi patient study, and the attenuation index map was set to correspond to a photon energy of 140 keV.

In this application, the dynamic planar images were simulated over a two minute interval with 100 msec. frames to provide a dynamic image of Z=1200 temporally contiguous frames (128×128 matrix), each of duration T=100 msec., thereby resulting in 1200 frames per data set. Each 100 msec frame consisted of 10×10⁶ photon simulations. A stationary (non-moved) image was also generated, consisting of 1.2×10¹⁰ photon simulations, the equivalent number of photons of the summed dynamic frames.

In accordance with an embodiment of the present invention, the binning module 130 motion segmented the frames into R=16 bins, using a window threshold value of T=2.25. Based on Equation (6), the pixel classification module 110 utilized a search window of width 0.075 Hz around the central respiratory frequency estimate of 0.225 Hz. As stated herein, since the respiratory cycle is typically 4.4 seconds, the pixel classification module 110 used 0.225 Hz as an estimate of respiratory frequency Fr.

After the frames have been placed in the appropriate bins, the bin alignment module 140 adjusted the alignment mask threshold until the liver and heart can be visualized as one isolated structure. Also, in accordance with an embodiment of the present invention, the bin alignment module 140 registered the bins using a 2-D rigid body 3 parameter model with a least square cost function and a rejection threshold of 25%.

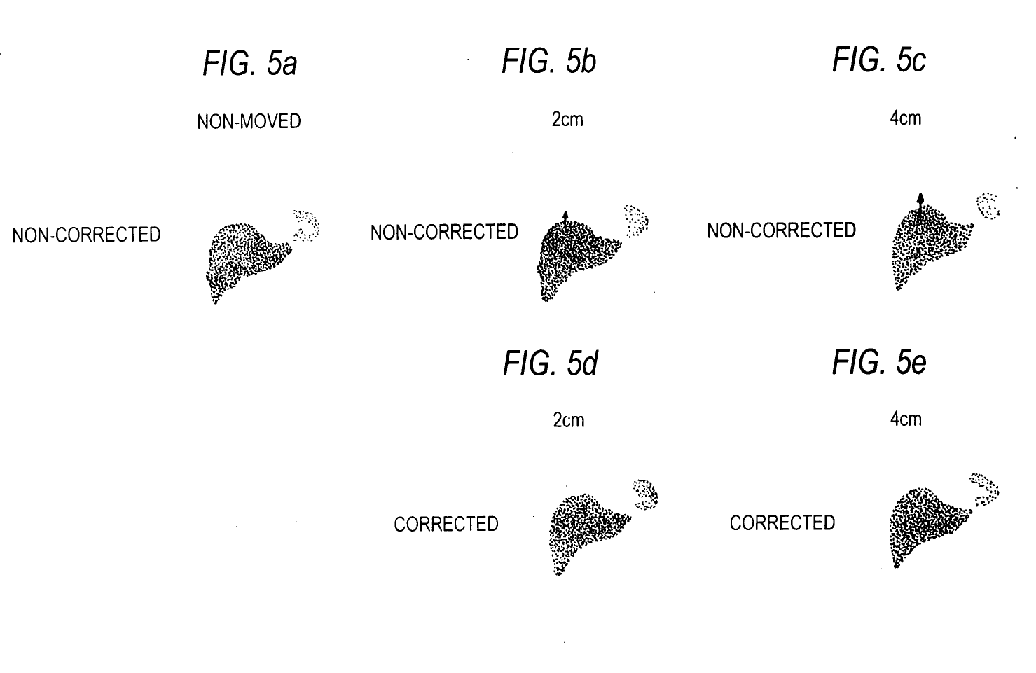

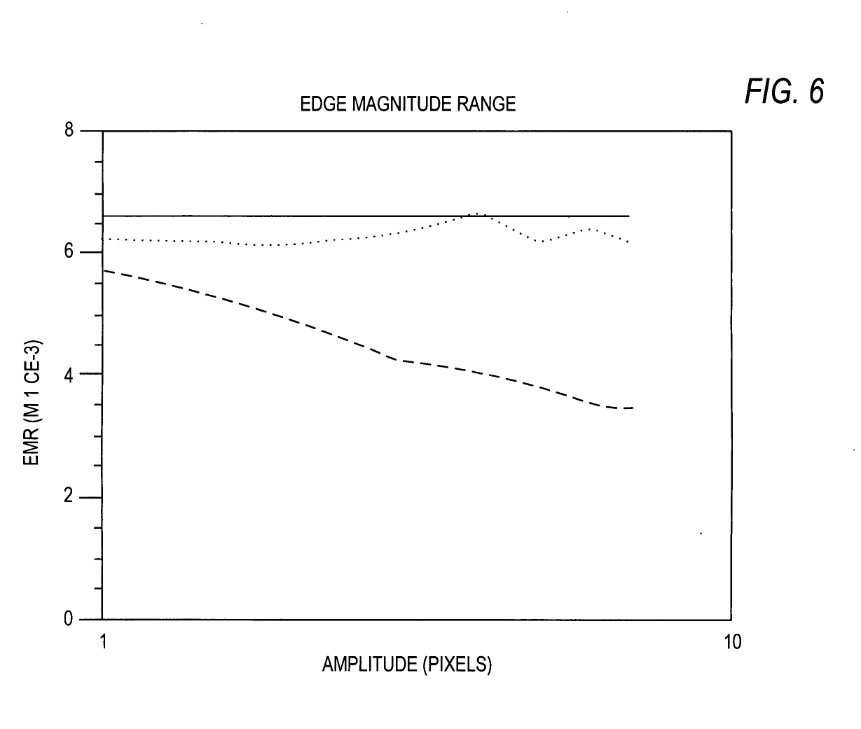

Turning now to FIGS. 5A-5E, there are illustrated various NCAT planar simulations of non-corrected and corrected image in accordance with an embodiment of the present invention. FIG. 5A represents a stationary (or non-moved) planar image, FIG. 5B represents non-corrected 2 cm amplitude NCAT planar simulated image (i.e., moved with 2 cm amplitude), FIG. 5C represents non-corrected 4 cm amplitude NCAT planar simulated image (i.e., moved with 4 cm amplitude), FIG. 5D represents corrected 2 cm amplitude NCAT simulated image, and FIG. 5E represents corrected 4 cm amplitude NCAT planar simulated image. The motion corrected images (FIGS. 5D and 5E), in accordance with an embodiment of the present invention, are comparable to the stationary (or non-moved) image of FIG. 5A, thereby illustrating the efficacy of the present invention. Also, in accordance with an embodiment of the present invention, the edge magnitude range module 150 calculated EMR values for the planar images of FIGS. 5A-5E, delineated in Table 1 and illustrated in FIG. 6. As shown in Table 1, the EMR value of 6.61×10³ for the stationary image of FIG. 5A reduces to 4.93×10³ and 4.08×10³, respectively, when respiratory motion amplitudes of 2 cm and 4 cm are present. However, when these respiratory motion induced images are corrected using the inventive system and method, the EMR values of the corrected images are 6.13×10³ and 6.67×10³, respectively, approaching the EMR value of the stationary image.

TABLE 1
EMR Values of Non-Corrected and Corrected Images

| | |
|---|---|
| Amplitude | EMR (×10⁻³) |

| Cm | Non-corrected | Corrected |
|---|---|---|
| 0 | 6.61 | |
| 1 | 5.73 | 6.21 |
| 2 | 4.93 | 6.13 |
| 3 | 4.23 | 6.32 |
| 4 | 4.08 | 6.67 |
| 5 | 3.75 | 6.18 |
| 6 | 3.54 | 6.40 |
| 7 | 3.43 | 6.15 |

As illustrated in FIGS. 3-6, the motion corrected images in accordance with an embodiment of the present invention are superior to the non-corrected images for all of the seven silmulated amplitudes of motion. The EMR values of the non-corrected images decreased with the increasing motion amplitude, reducing from 86.71% to 51.98% of the stationary EMR value, at respective amplitudes of 1 cm and 7 cm. Whereas, the EMR values of the images corrected in accordance with an embodiment of the present invention remained within 92.71% of the stationary EMR value, across the entire range of simulated motion amplitudes. Therefore, the present inventive method and system can be effectively used to reduce respiratory motion induced artifact in nuclear medicine image.

Planar Image Dosimetry Example

Organs analyzed during dosimetry analysis, such as the liver, heart, lungs, and spleen, etc., may be subject to significant motion, including, but not being limited to, respiratory motion. These organs are large enough to draw a smaller sample region well within the organ boundaries so that the partial volume effect is avoided. This sample region is then used to represent the entire organ by scaling to the area of the organ. Background is represented by another region of interest (ROI) which can be placed at a position where it is not affected by the organ motion, even during heavy respiration. Therefore, the derived counts of the organ (i.e., liver) is generally not effected by respiration provided that the activity distribution within the organ is homogeneous, and the edge (or the partial volume effects of the edge) do not enter the ROI. However, the determined area of the entire organ may vary according to the level of motion, thus affecting the calculated total counts-per-minute in the entire organ.

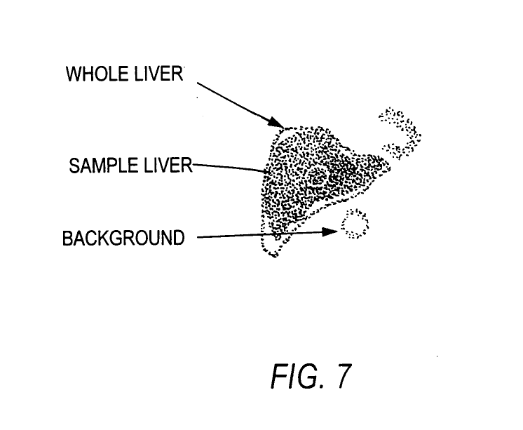

In this exemplary planar image dosimetry application of the present invention, the simulated planar NCAT images were used to assess the effects of respiratory motion on liver dosimetry. Three regions were placed on each image; the whole liver, a liver sample, and a liver background, as shown in FIG. 7.

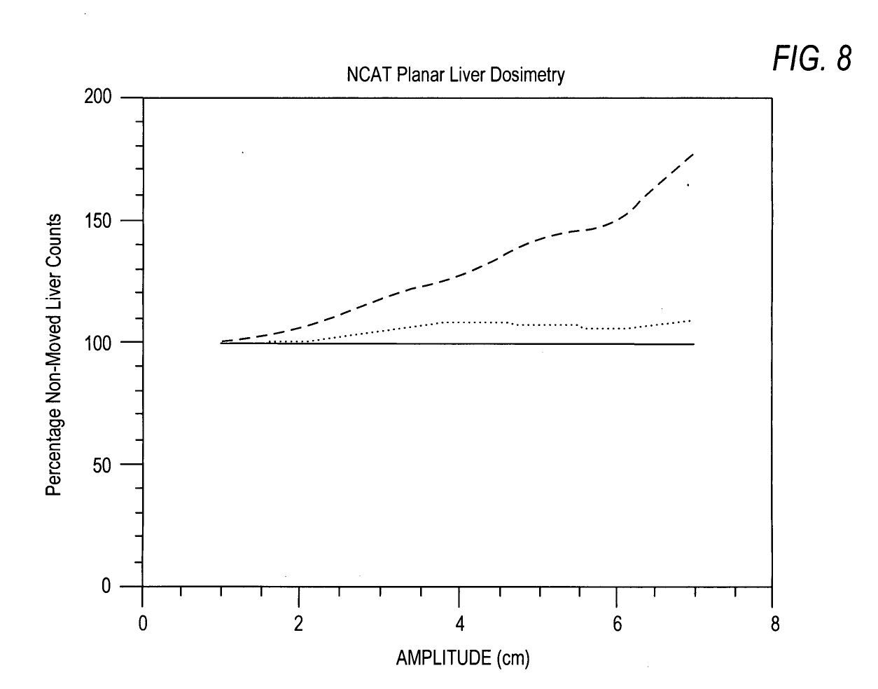

The inventive system and method analyzed images from multiple amplitudes of motion, with dosimetry performed on the corrected/moved, non-corrected/moved, and stationary (non-moved) images. In the non-corrected images, the area of the whole liver increased with the amplitude of motion. As a result, the organ counts also increased with the amplitude. As shown in FIG. 8, the liver counts calculated from the non-corrected images increased to 161% of the liver count value of the stationary image at an amplitude of 7 cm. This increase in the calculated liver counts was primarily due to the increase in whole liver area, as the counts in the sample region remained within 7% of the stationary sample count value, across the entire range of simulated amplitudes.

The inventive system and method defined ROIs on the corrected data that were within 3% of the corresponding area on stationary data. The total liver counts calculated from the corrected data using the inventive system and method remained within 9% of the stationary liver counts. Accordingly, it is apparent that the respiratory motion increases the calculated value of the organ dose determined from the planar imaging analysis. The level of respiratory motion induced degradation depends on the ratio of the motion amplitude to the organ size. For a given motion amplitude, respiratory motion has greater significance on the analysis of a smaller structure or organ, such as a tumor, than a larger organ, such as liver. This should not be construed as meaning that if respiratory motion is the type of motion under consideration only smaller structures may be analyzed.

Dosimetry also involves the analysis of images over a period of time which allows the estimation of the clearance rate. Accordingly, a series of images were simulated to assess the inventive motion correction system and method's ability to deal with reduced count rates. The functional or operational range of the inventive system and method depends on the distribution of counts in the image. It is appreciated for each acquired image, there is certain count rate threshold at which the signal power is not significantly greater than the noise power. Accordingly, the performance, i.e., the operational range, of the inventive system and method is determined by the signal to noise ratio (SNR) and of the acquired images. For example, the count rate threshold at which SNR is an issue for the inventive motion correction system and method was approximately 1.1 kcps (kilo counts per second) when planar images of an ellipsoid model phantom were simulated with 2 cm of respiratory motion. That is, for this example, the inventive motion correction system and method properly detected the respiratory induced motion with 100 msec. bins for count rates above 1.1 kcps.

In another application of the present invention, ¹³¹I labeled monoclonal antibody trials typically involve the acquisition of a series of images with a gamma camera over approximately one week following the infusion of the radioisotope labeled antibody. A sample patient from a trial who received 8.1 mCi of ¹³¹I labeled antibody, produced a count rate of 2.9 kcps during the day-five static image, which falls within the approximate functional range of the inventive motion correction system and method. While the count rate is dependent on the amount of activity infused, time between infusion and acquisition, the isotope, and the biological clearance of the compound, the radiolabeled antibody studies are another exemplary application of the inventive motion correction system and method. The required count rate is dependent on the observed SNR being greater than the specified threshold T, as defined by Equation (6) and which has been empirically set to 2.25 in this example.

The inventive motion correction system and method is applicable to any form of nuclear medicine imaging, where the image is degraded by any type of motion, including respiratory motion. The only requirement of the inventive system and method is that the image be acquired as a series of dynamic frames or in list mode, with sufficient count rate. In accordance with an embodiment of the present invention, the motion correction system and method can be applied to any clinical studies, such as lung, cardiac, liver and renal studies. Where registration and summation of bins is inappropriate, such as for lung perfusion studies, the inventive system and method can utilize near motion-free bins. These near motion-free bins provide reduced motion artifact, as well as other information relating to respiratory motion physiology. It is appreciated that the inventive system and method does not increase the data acquisition time, and can reconstruct the original, non-corrected data by summing the dynamic series.

In accordance with an embodiment of the present invention, the motion correction system and method can be extended to PET acquired images (or PET acquisition) to correct respiratory motion induced attenuation inaccuracies in images acquired on the combined PET/CT cameras. Data gating the PET acquisition in accordance with an embodiment of the present invention can provide a near motion-free bin, which would anatomically correspond to the computed tomography (CT) performed under a given level of inspired breath-hold condition. In accordance with an aspect of the present invention, the inventive system and method can utilize a deformable registration to align the bin with the CT. It is appreciated that in accordance with an aspect of the present invention, the motion correction system and method provides a means for defining near-motion-free frames that contribute to a given near motion-free bin. Since the present invention is not dependent on any image registration algorithm, the inventive motion correction system and method can utilize non-deformable and deformable registration algorithms to motion correct non-deformable motion (e.g., liver) and deformable motion (e.g., lung), respectively.

In accordance with an embodiment of the present invention, the motion correction system and method can be applied to minimize the affects of respiratory induced motion in planar image dosimetry, which can cause significant quantitative image degradation. The inventive method is a data-driven method of respiratory gating, which produces a series of near motion-free bins. The inventive system and method utilizes these near motion-free bins to reduce motion artifact and provide additional information relating to respiratory mechanics that may be of diagnostic interest, or registered with respect to an organ of interest, and summed to create a single motion corrected image.

The inventive motion correction system and method produces motion corrected images that are superior to the non-corrected images in various metrics, such as EMR values, image quality and the like. As described herein, liver dosimetry analysis of non-corrected images showed significant loss of accuracy, due to the over estimation of organ area. The inventive system and method significantly and consistently restored dosimetric accuracy when these same images were motion corrected in accordance with an embodiment of the present invention.

It is appreciated that the application of the inventive motion gating and correction exists across a wide range of imaging modalities, providing the data can be acquired as a series of dynamic frames or in list mode. The inventive system and method can be used with any nuclear imaging device and system without any additional hardware and without increasing the image acquisition time or duration. Also, the inventive process is non-destructive, such that the original, non-corrected image can be reconstructed by summing the non-aligned bins.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of correcting motion in nuclear image, comprising the steps of:
filtering an image of a moving target structure comprising series of frames to generate a binary mask;
phase weighting said binary mask with a phase to provide a phase weighted mask;
convolving said series of frames with said phase weighted mask to generate a series of near motion-free bins; and
aligning said near motion-free bins to provide a motion corrected image of said target structure.

2. The method of claim 1, wherein the step of filtering comprises the step of temporally and spatially Gaussian smoothing said series of frames.

3. The method of claim 2, wherein the step of filtering comprises the step of fast Fourier transforming said series of frames.

4. The method of claim 3, wherein the motion is respiratory induced motion; and wherein the step of filtering includes the step of applying said binary mask to said series of frames, thereby eliminating pixels not demonstrating respiratory motion characteristics.

5. The method of claim 3, wherein the step of filtering comprises the step of determining a ratio of respiratory signal power to non-respiratory signal power.

6. The method of claim 1, wherein the step of phase weighting comprises the step of generating a phase histogram and a histogram peak.

7. The method of claim 1, wherein the step of phase weighting comprises the step of identifying an edge with strongest specific frequency characteristics as being said phase.

8. The method of claim 1, wherein the step of convolving comprises the step of initializing a series of R displacement bins.

9. The method of claim 8, wherein the step of convolving comprises the steps of generating counts-time series, low-pass filtering said counts-time series, and dividing said filtered counts-time series into R equally sized displacement bins.

10. The method of claim 1, wherein the step of aligning comprises the step of registering said near motion-free bins.

11. The method of claim 10, wherein the step of registering comprises the steps of adjusting threshold of summed frames until said target structure is not connected to any adjacent structures; and selecting a seed point within said target structure.

12. The method of claim 11, wherein the step of aligning comprises the steps of generating a target structure specific binary mask from said seed point; and morphologically dilating said target structure specific binary mask to provide a dilated mask.

13. The method of claim 12, wherein the step of aligning comprises the steps of applying said dilated mask to said near motion-free bins to provide aligned bins and summing said aligned bins to provide said motion corrected image of said target structure.

14. The method of claim 1, further comprising the step of calculating an edge magnitude range metric of said motion corrected image.

15. The method of claim 1, wherein said target structure is an organ; and wherein the step of filtering includes the step of filtering said image of said organ.

16. The method of claim 1, wherein said target structure is a tumor; and wherein the step of filtering includes the step of filtering said image of said tumor.

17. The method of claim 1, wherein said series of frames being series of dynamic frames; and wherein the step of filtering includes the step of filtering said series of dynamic frames to generate said binary mask.

18. The method of claim 1, wherein said image being list mode acquired data framed into said series of frames; and wherein the step of filtering includes the step of filtering said framed list mode acquired data.

19. The method of claim 1, wherein the step of acquiring includes the step of acquiring at least one of the following image: single photon computed tomography (SPECT) image, positron emission tomography (PET) image and computed tomography (CT) image.

20. A system for correcting motion in nuclear imaging, comprising:
a pixel classification module for filtering an image of a moving target structure comprising a series of frames to generate a binary mask;
a phase weighting module for phase weighting said binary mask with a phase to provide a phase weighted mask;
a binning module for convolving said series of frames with said phase weighted mask to generate a series of near motion-free bins; and
a bin alignment module for aligning said near motion-free bins to provide a motion corrected image of said target structure.

21. The system of claim 20, further comprising an edge magnitude range module for calculating an edge magnitude range metric of said motion corrected image.

22. The system of claim 20, wherein the motion is respiratory induced motion; and wherein said pixel classification module is operable to apply said binary mask to said series of frames, thereby eliminating pixels not demonstrating respiratory motion characteristics.

23. The system of claim 20, wherein said bin alignment module is operable to select a seed point within said target structure; generate a target structure specific binary mask from said seed point; and morphologically dilate said target structure specific binary mask to provide a dilated mask; said dilated mask to said near motion-free bins to provide aligned bins; and sum said aligned bins to provide said motion corrected image of said target structure.

24. A computer readable medium comprising code for correcting motion in nuclear imaging, said code comprising instructions for:
filtering an image of a moving target structure comprising a series of frames to generate a binary mask;
phase weighting said binary mask with a phase to provide a phase weighted mask;
convolving said series of frames with said phase weighted mask to generate a series of near motion-free bins; and
aligning said near motion-free bins to provide a motion corrected image of said target structure.

25. The computer readable medium of claim 24, wherein the motion is respiratory induced motion; and wherein said code further comprises instructions for applying said binary mask to said series of frames, thereby eliminating pixels not demonstrating respiratory motion characteristics.

26. The computer readable medium of claim 24, wherein said code further comprises instructions for selecting a seed point within said target structure; generating a target structure specific binary mask from said seed point; morphologically dilating said target structure specific binary mask to provide a dilated mask; applying said dilated mask to said near motion-free bins to provide aligned bins; and summing said aligned bins to provide said motion corrected image of said target structure.

27. The computer readable medium of claim 24, wherein said code further comprises instructions for calculating an edge magnitude range metric of said motion corrected image.
